(19) United States
(12) Patent Application Publication
(10) Pub. No.: US 2012/0022845 A1
(43) Pub. Date: Jan. 26, 2012

(54) MONITORING OF THE RADIATION DOSE ACCUMULATED BY A BODY

(76) Inventors: Vincent Bismuth, Paris (FR); Sebastien Gorges, Versailles (FR); Regis Vaillant, Villebon sur Yvette (FR); Lionel Desponds, St-Remy-les-chevreuse (FR)

(21) Appl. No.: 13/186,757

(22) Filed: Jul. 20, 2011

(30) Foreign Application Priority Data
Jul. 26, 2010 (FR) 1056090

(51) Int. Cl. G06G 7/60

(52) U.S. Cl. 703/11

(57) ABSTRACT

The embodiments of the invention pertain to a method, a computer program, and an imaging system used to monitor the dose of radiation accumulated in a body or a part of a body being or having been subject to radiation exposure during an acquisition of at least one radiological image, comprising: processing the at least one radiological image to determine a 3D model of the body or of the part of a body; applying a theoretical model for the interactions between matter and radiation to the 3D model; storing in memory the parameters characteristic of the emission of radiation produced during the acquisition of the at least one radiological image; and calculating a distribution of an accumulated radiation dose in the body or the part of a body which has been the subject of the acquisition of the at least one radiological image.

### BACKGROUND OF THE INVENTION

1. Field of the Invention

In general, the field of invention relates to medical imaging by radiation. More particularly, it concerns the estimation and the monitoring of doses of radiation to which a body or certain organs thereof are subjected when acquiring images. It finds particular application in the real-time monitoring of doses of radiation to which a patient is subjected during interventional radiography.

2. Description of Related Art

It is known that the exposure of a subject or organ thereof to an X-ray dose produces two types of effects: long-term, stochastic effects (risk of cancer), which are related to the dose accumulated by a patient throughout a lifetime, where any radiation dose must be offset by the benefit for the patient; and short-term effects, in the hours, days and weeks following exposure (burns), which are related to exposure for a short time at a very high dose.

Yet, imaging by radiation can expose the body of a subject or certain parts thereof to doses of radiation which may vary greatly from one acquisition to another, in particular in relation to the chosen angles of exposure. Additionally, radiation, notably X-ray radiation, interacts very differently with the bones or tissue of the human body, which prevents an easy determination of the level of radiation to which a given part of the body can still be exposed. There is therefore a need for a tool enabling a user to estimate the distribution of the doses of radiation received by a body or by different parts of a body during the acquisition of one or more radiological images.

It is also desired, during the acquisition of new images, to avoid accumulating doses of radiation that are too high in some regions of the body or in some organs, and consequently to be able to define the conditions for the acquisition of subsequent images, which allows the optimization of the doses of radiation accumulated in a body. Methods are already known allowing an estimate of the distribution of the doses of radiation accumulated by a body. However, the known methods use homogeneous cylinder-body modelling, for example, and do not take into account the specificities of the morphology of each subject or of the different organs forming the body thereof.

### BRIEF SUMMARY OF THE INVENTION

According to the embodiments of the present invention, there is provided a method to monitor the dose of radiation accumulated in a body or a part of a body being or having been subject to radiation exposure during an acquisition of at least one radiological image, comprising: processing the at least one radiological image to determine a 3D model of the body or of the part of a body, wherein the 3D model identifies different elements of the body or the part of a body that has been imaged; applying a theoretical model for the interactions between matter and radiation to the 3D model; storing in memory the parameters characteristic of the emission of radiation produced during the acquisition of the at least one radiological image; and calculating a distribution of an accumulated radiation dose in the body or the part of a body which has been the subject of the acquisition of the at least one radiological image.

According to another aspect, there is provided a computer program comprising code instructions capable of implementing a method to monitor the dose of radiation accumulated in a body or a part of a body being or having been subject to radiation exposure during an acquisition of at least one radiological image, when said programme is read by a computer, wherein the method comprises: processing the at least one radiological image to determine a 3D model of the body or of the part of a body, wherein the 3D model identifies different elements of the body or the part of a body that has been imaged; applying a theoretical model for the interactions between matter and radiation to the 3D model; storing in memory the parameters characteristic of the emission of radiation produced during the acquisition of the at least one radiological image; and calculating a distribution of an accumulated radiation dose in the body or the part of a body which has been the subject of the acquisition of the at least one radiological image.

According to a further aspect, there is provided a computer program product comprising code instructions stored on a medium capable of being read by a computer, and comprising means capable of implementing the different steps of the method to monitor the dose of radiation accumulated in a body or a part of a body being or having been subject to radiation exposure during an acquisition of at least one radiological image, when said programme is read by a computer, wherein the method comprises: processing the at least one radiological image to determine a 3D model of the body or of the part of a body, wherein the 3D model identifies different elements of the body or the part of a body that has been imaged; applying a theoretical model for the interactions between matter and radiation to the 3D model; storing in memory the parameters characteristic of the emission of radiation produced during the acquisition of the at least one radiological image; and calculating a distribution of an accumulated radiation dose in the body or the part of a body which has been the subject of the acquisition of the at least one radiological image.

According to a further aspect, there is provided a medical imaging system comprising: a table; a radiation emission device and an opposite-facing acquisition device, both arranged on a support that is mobile relative to the table; a computer programmed to implement a method to monitor the dose of radiation accumulated in a body or a part of a body being or having been subject to radiation exposure during an acquisition of at least one radiological image, wherein the method comprises: processing the at least one radiological image to determine a 3D model of the body or of the part of a body, wherein the 3D model identifies different elements of the body or the part of a body that has been imaged; applying a theoretical model for the interactions between matter and radiation to the 3D model; storing in memory the parameters characteristic of the emission of radiation produced during the acquisition of the at least one radiological image; and calculating a distribution of an accumulated radiation dose in the body or the part of a body which has been the subject of the acquisition of the at least one radiological image.

### BRIEF DESCRIPTION OF THE SEVERAL VIEWS OF THE DRAWINGS

Other characteristics, purposes and advantages of the embodiments of the invention will become apparent from the following description, which is solely illustrative and is non-limiting, and is to be read in connection with the appended drawings in which:

FIG. 1 is a schematic illustration of an imaging device;

FIG. 2 illustrates the steps of a method conforming to an embodiment of the invention, able to be implemented with the device in FIG. 1;

FIGS. 3 illustrates another possible embodiment; and

FIG. 4 illustrates yet another possible embodiment.

### DETAILED DESCRIPTION OF THE INVENTION

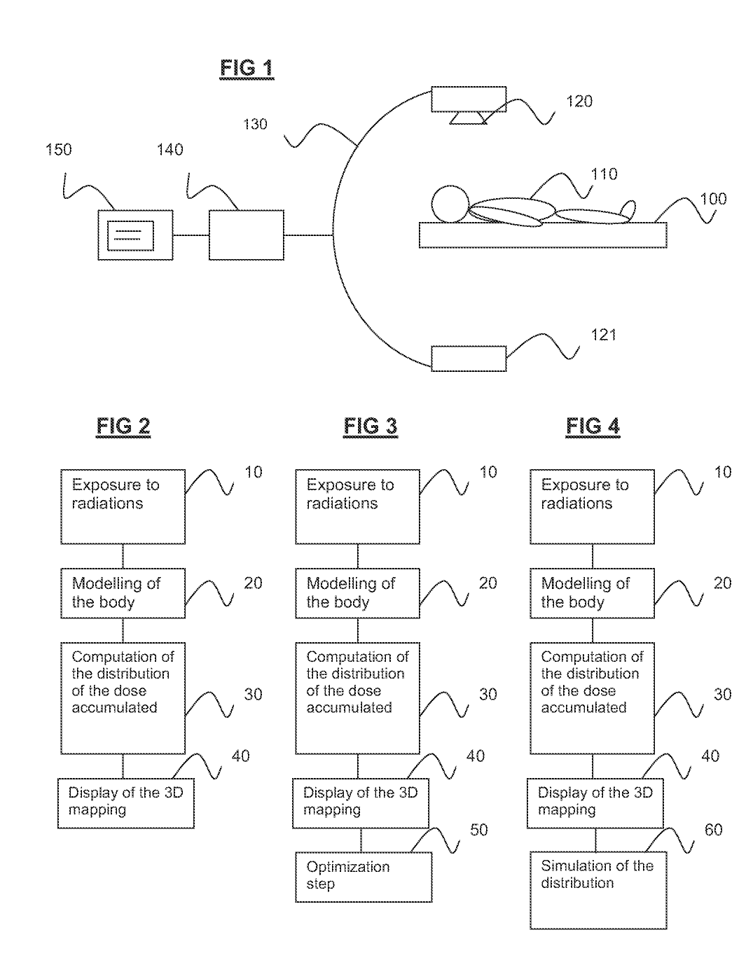

FIG. 1 schematically illustrates a C-arm imaging device. The device comprises: a table 100 on which the subject 110 is positioned, an emission source 120 (e.g. X-ray source) arranged at one end of a C-arm 130, a detector 121—for example an array of digital sensors—positioned facing the emission source 120, on the other side of the table 100 and subject 110, and carried by the other end of the C-arm 130. The C-arm 130 is mobile relative to the table 100. It can be tilted to allow different exposure angles. It can also be moved longitudinally along the table.

In other embodiments, or to supplement the mobility of the C-arm 130, the table 100 is mobile to offer greater flexibility in the different movements. The device also comprises a computer 140 or set of computers, receiving the images acquired by the detector 121 and programmed to process these images and perform the steps described below with reference to FIGS. 2 through 4. The computer can additionally be combined with a display 150 to display the result of this processing.

in FIG. 2, in a first step 10, a body 110 or part thereof, is exposed to a dose of radiation during the acquisition of initial 2D images of a patient undergoing a procedure. In a second step 20, based on these 2D images, the computer 140 models in 3D the subject or the part thereof which has been the subject of the image acquisition, and processes the information to produce a 3D model of the body or the part of the body for which the images have been acquired. The processing applied uses segmenting and reconstruction techniques known in the art. The processing also identifies, in the 3D model, different elements or organs of the body of the patient (bone, flesh, heart, liver, and/or lungs for example). Therefore, the 3D model takes into account the variations in density of the different elements forming the body of the subject, and is not limited to models reduced to simple geometric shapes having homogeneous density.

The 3D model can be obtained, for example, in the manner described in the article “3D reconstruction of the human rib cage from 2D projection images using a statistical shape model; Jalda Dworzak et at. Int J Cars (2010) 5:111-124”. In particular, with the technique proposed in this publication, the patient's body is reconstructed in 3D avoiding a rotational acquisition if such rotation requires an X-ray dose in addition to the standard examination, and the images are used for this purpose that are naturally acquired during the examination. For example, in interventional cardiology, 2D images are acquired over a certain set of angles around the patient's body during the diagnosis phase. These images, of a restricted number of views, are processed by the computer 140 which reconstructs the anatomic structures for which statistical shape models are available.

At a step 30, the computer 140 applies a previously stored, theoretical model of radiation absorption and diffusion in the patient's body to the 3D model. The computer computes the distribution of the doses of radiation accumulated in the different parts of the patient for the 3D model based on the theoretical model and a number of additional pieces of information regarding the parameters of image acquisition. The theoretical model, for example, is of the type described in numerous recent studies using Geant4 software to model and simulate the interaction of photons with matter, e.g.: “Performance of GEANT4 in dosimetry applications: Calculation of X-ray spectra and kerma-to-dose equivalent conversion coefficients; Carla C. Guimaraes, Mauricio Moralles, Emico Okuno; Radiation Measurements 43 (2008) 1525-1531”. The parameters that are taken into account and applied to this model are, for example: the emission characteristics (voltage in kV, intensity in mA), the properties of the emission tube, the focal spot size of emission, and the properties of the body of the subject under consideration, notably the densities and different properties of the different organs of the subject's skeleton. Several levels of precision can be obtained, for example, by only taking into account the absorbed radiation, or by also taking X-ray diffusion into account.

It will be noted here that this step does not require any additional capture instruments, which allows a device for the implementation of this method to retain substantially similar structure to that of a conventional imaging device, with the exception of the computing resources.

At a step 40, the computer 140 controls the display to show the 3D mapping of the accumulated doses of radiation, typically by presenting a 3D image with gradations of colours corresponding to different levels of cumulative doses of radiation. Determining the distribution of an X-ray dose in the body of a subject can be exploited in several ways. For example, it can be used to verify that the exposure was conducted safely for the subject, by not excessively exposing certain parts of the subject's body. It can also be used to determine the best directions for exposure to be used for subsequent exposures, so as not to expose some parts of the subject's body to an excessive radiation dose. The modelling can be updated on each new acquired 2D image. The distribution of accumulated dose can then optionally be re-calculated.

So far, the process to obtain the 3D model, particularly the first 3D model, has used 2D images acquired during an interventional procedure. It is also possible to use 3D images acquired prior to an intervention procedure from, for example, CT or MRL for the modelling process. Processing to adjust subsequently acquired images from the original 3D image is then of course necessary. Moreover, as illustrated by the example in FIG. 3, it is possible to provide an additional optimization step 50, which consists of determining the best directions for exposure so as not to expose some regions of the subject's body to an X-ray dose that is too high.

Similar to the determination step 30 described previously, the optimization step 50 takes numerous parameters in account, for example: the characteristics of the X-rays to be emitted, the properties of the X-ray emission tube, the focal spot size of emission, and the properties of the subject's body, notably the densities and different properties of the subject's different organs and skeleton. Additionally, this optimization step 50 takes into account the regions of interest in the subject i.e. those regions for which precise modelling is desired, typically an internal organ or a part of the body in the case of medical imaging. These regions of interest are either determined automatically in relation to the X-rays emitted during the first application step 10, for example by determining the intersection(s) of the X-ray beams emitted during this first application step 10, or they are designated by an operator typically on a device controlling an X-ray emitting device. The optimization step will therefore determine the directions that best distribute the dose of radiation in a substantially uniform and homogeneous manner over the different regions of the subject's body, while obtaining a precise model of the regions of interest.

This optimization step can be used to automate an X-ray emission device. For the imaging of coronary arteries, for example, a very few number of angles allows the system to determine a set of positions in space in which the C-arm is to be positioned so that the visual effects of projective narrowing of the arteries are minimized. This is notably made possible with the system described in: “Computer-assisted positioning—Compas” by GE Healthcare, also described in the article “Optimizing coronary angiographic views; G Finet, J Liénard; The International Journal of Cardiac Imaging; Volume 11, Supplement 1/March, 1995”). On this principle, the computer 140 determines and displays on the screen the dose that has been reached in this set of views. It also selects a proposed view for the following angles, while paying heed to all angles of interest identified by a Compas-type procedure, preventing the accumulation of a certain maximum dose on any given part of the anatomy, and seeking an angle close to the current working angle. A validation step by an operator can be added prior to each emission, so that the exposure procedure remains under the supervision of a qualified person.

It will also be noted that with the different data given to the computer 140 on the different emitted radiations, it is also possible for the computer to compute an estimate of radiation diffusions outside the patient, for example in the radiology room, and to display a depiction of this information (mapping of the room) for use by practitioners and assistants in the room.

FIG. 4 illustrates another variant of the method in which the optimization step 50 is replaced by a simulation step 60, which indicates to the operator of the device the distribution of the X-ray dose in the body of a subject which would be obtained if the subject were to be subjected to exposure under given conditions, for example, in a given direction. As an example of use of this variant, the case can be cited in which, subsequent to the first three steps 10, 20 and 30, the X-ray emission system is moved by the operator of the device to orientate it in a given direction, at which point the device will indicate the consequences of such orientation in terms of the exposure to the subject, or more precisely the subsequent distribution of the X-ray dose in the subject's body as a result from exposure from this given direction.

These optimization 50 and simulation 60 steps can both be implemented by a computer, which may or may not be the same as the one or those used to implement the steps of subject modelling and determining of the distribution of the X-ray dose in the subject's body.

Similarly, this computer can be combined with display means, for example to illustrate the directions defined in the case of optimization, or the distribution of the X-ray dose in the subject's body in the case of simulation, so that an operator is able to determine how to proceed with X-ray exposure of the subject.

What is claimed is:

1. A method to monitor the dose of radiation accumulated in a body or a part of a body being or having been subject to radiation exposure during an acquisition of at least one radiological image, the method comprising:
processing the at least one radiological image to determine a 3D model of the body or of the part of a body, wherein the 3D model identifies different elements of the body or the part of a body that has been imaged;
applying a theoretical model for the interactions between matter and radiation to the 3D model;
storing in memory the parameters characteristic of the emission of radiation produced during the acquisition of the at least one radiological image; and
calculating a distribution of an accumulated radiation dose in the body or the part of a body which has been the subject of the acquisition of the at least one radiological image.

2. The method according to claim 1 further comprising, prior to the acquisition of at least one radiological image, simulating the distribution of the accumulated dose for different acquisition conditions for new images, in order to select at least one optimized condition for the acquisition of the new images.

3. The method according to claim 2, further comprising simulating the distribution of the accumulated dose for different radiation emission directions.

4. The method according to claim 1, wherein the 3D model is updated for each radiological image acquired.

5. The method according to claim 3, wherein simulating the distribution of the accumulated dose is re-calculated for each radiological image acquired.

6. The method according to claim 1, wherein the images processed to determine a first 3D model are 2D images acquired during an intervention.

7. The method according to claim 1, wherein at least one image processed to determine a first 3D model is a 3D image previously acquired before an intervention.

8. The method according to claim 1, wherein at least one image processed to determine a first 3D model is a 3D image previously acquired before an intervention, the 3D model is updated for each radiological image acquired, and the images subsequently acquired are processed to adjust to the 3D image previously acquired.

9. The method according to claim 1, further comprising displaying a 3D representation of the distribution of the accumulated dose of radiation in the body or in the part of a body which had been the subject of the acquisition of the at least one radiological image.

10. The method according to claim 1, further comprising estimating X-ray diffusions outside the body, and displaying the estimate.

11. A computer program comprising code instructions capable of implementing a method to monitor the dose of radiation accumulated in a body or a part of a body being or having been subject to radiation exposure during an acquisition of at least one radiological image, when said programme is read by a computer, wherein the method comprises:
processing the at least one radiological image to determine a 3D model of the body or of the part of a body, wherein the 3D model identities different elements of the body or the part of a body that has been imaged;
applying a theoretical model for the interactions between matter and radiation to the 3D model;
storing in memory the parameters characteristic of the emission of radiation produced during the acquisition of the at least one radiological image; and
calculating a distribution of an accumulated radiation dose in the body or the part of a body which has been the subject of the acquisition of the at least one radiological image.

12. A medical imaging system comprising:
a table;
a radiation emission device and an opposite-facing acquisition device, both arranged on a support that is mobile relative to the table; and
a computer programmed to implement a method to monitor the dose of radiation accumulated in a body or a part of a body being or having been subject to radiation exposure during an acquisition of at least one radiological image, wherein the method comprises:
processing the at least one radiological image to determine a 3D model of the body or of the part of a body, wherein the 3D model identifies different elements of the body or the part of a body that has been imaged;
applying a theoretical model for the interactions between matter and radiation to the 3D model;
storing in memory the parameters characteristic of the emission of radiation produced during the acquisition of the at least one radiological image; and
calculating a distribution of an accumulated radiation dose in the body or the part of a body which has been the subject of the acquisition of the at least one radiological image.
